(19) United States
(12) Patent Application Publication
(10) Pub. No.: US 2019/0108489 A1
(43) Pub. Date: Apr. 11, 2019

(54) SYSTEMS AND METHODS TO MANAGE EMPLOYEE BENEFITS

(71) Applicant: Paydaptive LLC, Colleyville, TX (US)

(72) Inventor: Kerissa HOLLIS, Grapevine, TX (US)

(21) Appl. No.: 16/153,599

(22) Filed: Oct. 5, 2018

Related U.S. Application Data
(60) Provisional application No. 62/568,653, filed on Oct. 5, 2017.

(51) Int. Cl. G06Q 10/10; G06Q 10/06; G06Q 40/00

(52) U.S. Cl. CPC G06Q 10/1057; G06Q 40/125; G06Q 10/06398

(57) ABSTRACT

The disclosed embodiments include systems and methods to manage employee payroll. In one of such embodiments, the method includes receiving a request from an employer to provide a benefit to an employee of the employer. The method also includes determining, based on a set of business rules for determining employee benefits, at least one benefit qualified for the employee. The method further includes providing the at least one benefit qualified for the employee for display on an electronic device of the employer. The method further includes receiving a request from the employer to select a benefit of the at least one benefit. The method further includes authorizing the benefit selected by the employer to be disbursed to the employer. The method further includes updating a payroll account of the employer based on a benefit value of the benefit selected by the employer.

### BACKGROUND

The present disclosure relates generally to systems and methods to manage employee benefits.

Employees typically receive cash or non-cash payments from their employers on a periodic basis (such as weekly, bi-weekly, twice a month, monthly, or another quantifiable period) in exchange for performing services on behalf of their employers (such cash or non-cash payments are collectively referred to herein as “compensation”). The employees may elect to spend a portion of their compensation on housing, transportation, utilities, food, healthcare, entertainment, as well as other types of expenses (collectively “expenditures”).

Unexpected expenses may arise for employees that require immediately available funds prior to the time that the employee is scheduled to receive a paycheck. Employees may elect to pay for expenditures with credit (such as a credit card) from financial institutions. However, the employee may not have sufficient credit or may not be deemed to be creditworthy to pay for the expenditures. The employee may seek alternate credit or advance payment arrangements from third parties. Such alternate credit or advance payment arrangements are often provided in return for a portion of the employee's compensation, or based on the value of the employee's collateral. However, such advance payment arrangements often include terms that are significantly unfavorable to the employee or are made by untrustworthy individuals, high-interest finance companies, or institutions. Employers may desire to offer their employees a benefit to address situations where unexpected expenses arise for such employees.

### BRIEF SUMMARY OF THE DISCLOSED EMBODIMENTS

The disclosed embodiments provide systems and methods to manage employee benefits. In accordance with one embodiment, a computer-implemented method to manage employee benefits is provided. The method includes receiving a request from an employer to provide a benefit to an employee of the employer. The method also includes determining, based on a set of business rules for determining employee benefits, at least one benefit qualified for the employee. The method further includes providing the at least one benefit qualified for the employee for display on an electronic device of the employer. The method further includes receiving a request from the employer to select a benefit of the at least one benefit. The method further includes authorizing the benefit selected by the employer to be disbursed to the employer.

In accordance with another illustrative embodiment, an employee benefits management system is provided. The system includes a processor operable to receive a request from an employer to provide a benefit to an employee of the employer. The processor is further operable to determine, based on a set of business rules for determining employee benefits, at least one benefit qualified for the employee. The processor is further operable to provide the at least one benefit qualified for the employee for display on an electronic device of the employee. The processor is further operable to receive a request from the employee to select a benefit of the at least one benefit. The processor is further operable to authorize the benefit selected by the employee to be provided to the employee. The processor is further operable to update a payroll account of the employer to reflect the benefit selected by the employer.

In accordance with a further illustrative embodiment, a non-transitory machine-readable medium is provided. The non-transitory machine-readable medium includes instructions stored therein, which when executed by one or more processors, cause the one or more processors to perform operations including receiving a request from an employer to provide a benefit to an employee of the employer. The instructions also include instructions which cause the one or more processors to perform operations including determining, based on a set of business rules for determining employee benefits, at least one benefit the employee has accrued. The instructions also include instructions which cause the one or more processors to perform operations including providing the at least one benefit the employee for display on an electronic device of the employer. The instructions also include instructions which cause the one or more processors to perform operations including receiving a request from the employer to select a benefit of the at least one benefit. The instructions also include instructions which cause the one or more processors to perform operations including authorizing the benefit selected by the employer to be provided to the employer. The instructions also include instructions which cause the one or more processors to perform operations including determining a charge associated with providing the benefit selected by the employer. The instructions also include instructions which cause the one or more processors to perform operations including updating a balance of an employer charge account based on the charge, wherein the balance of the employer charge account is indicative of an amount owed by the employer. The instructions also include instructions which cause the one or more processors to perform operations including updating a payroll account of the employer to reflect the benefit selected by the employer. The instructions also include instructions which cause the one or more processors to perform operations including providing the electronic device of the employer with access to the employer charge account and the payroll account of the employer.

### BRIEF DESCRIPTION OF THE DRAWINGS

Illustrative embodiments of the present invention are described in detail below with reference to the attached drawing Figures, which are incorporated by reference herein, and wherein:

FIG. 1 is a network environment for managing employee benefits in accordance with one embodiment.

FIG. 2 is a tree diagram illustrating a process to determine employee qualified benefits in accordance in accordance with one embodiment.

FIG. 3 is a tree diagram illustrating a process to determine a value of an employee benefit in accordance in accordance with one embodiment.

FIG. 4 is a block diagram illustrating interactions between the employee, the employer, and the Company in accordance with one embodiment.

FIG. 5 is a flowchart illustrating a process to manage employee benefits in accordance with one embodiment.

The illustrated figures are only exemplary and are not intended to assert or imply any limitation with regard to the environment, architecture, design, or process in which different embodiments may be implemented.

### DETAILED DESCRIPTION

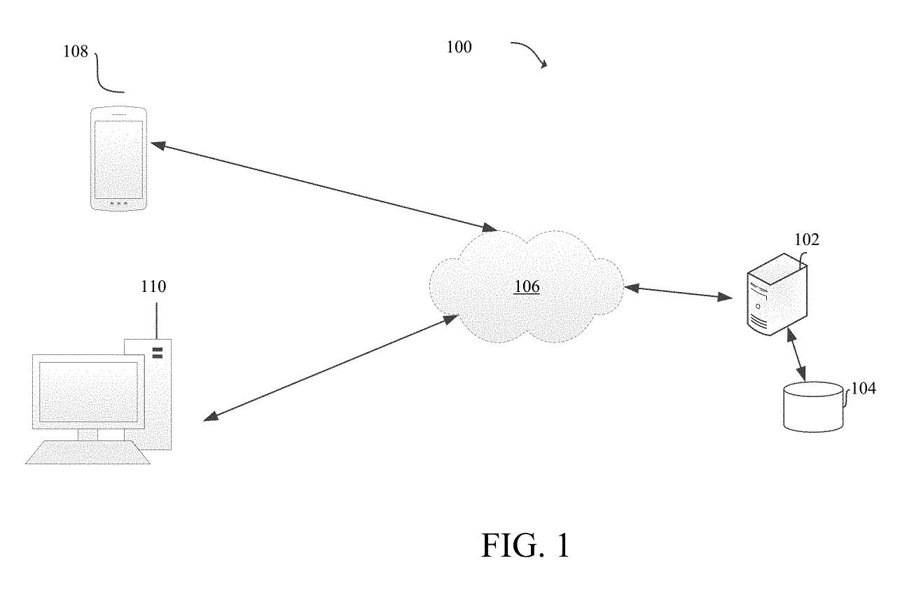

The present disclosure relates to a third-party software platform running on an employee benefits management system and operable to perform a variety of operations including managing multi-date payroll benefit programs on behalf of an employer, financing the employer's benefit programs, performing payroll, accounting and tax activities to facilitate and effectuate the benefit program, as well as a variety of financial operations described herein. The employer provides the employee benefits management system with benefit programs that the employer has established for its employees as well as rules defining qualifications of the benefit programs and benefit values of such benefit programs. The employee benefits management system is communicatively connected to the employer's electronic devices to provide the employer with access to the employer's benefits programs. The employee benefits management system, upon receipt of a request from the employer to finance a benefit, determines the benefit value of the benefit (including applicable taxes to be withheld as well as charges associated with providing the benefit). The employee benefits management system updates the employer's payroll, accounting, tax, as well as other financial accounts once the benefit is provided to the employer (to be subsequently provided to the employee). For example, the employee benefits management system, upon determining that the benefit is a payment of $1,000 to be transmitted one week prior to the next pay date of the employee (an alternate payday payment as defined below), is operable to calculate applicable taxes and charges, adjust the alternate payday payment to account for the taxes and charges, authorize the alternate pay date payment to the employer, and adjust the employer's payroll, tax return, benefits, as well as other financial accounts once the alternate pay date payment is made to the employer. Additional descriptions of the foregoing system and method to manage employee benefits, types of benefit programs, rules for determining which benefits are available to an employee, and rules for determining the benefit values of such benefits are described in the paragraphs below and are illustrated in FIGS. 1-4.

Turning now to the figures, FIG. 1 is a network environment 100 for managing employee benefits in accordance with one embodiment. The network environment 100 includes a first electronic device 108 of an employee and a second electronic device 110 of an employer of the employee, both communicatively connected to an employee benefits management system 102 via a network 106. As defined herein, an employer is any form of entity (including, but not limited to, individuals, corporations, non-profit organizations, governmental organizations, as well as other forms of entities) that provides its employees with compensation. Moreover, and as defined herein, an employee is any individual (regardless of position) who receives compensation from such individual's employer. Further, as defined herein, Company is any individual or entity that owns the employee benefits management system 102 and provides one or more benefits selected by the employer (or by the employee with the permission of the employer) to the employer.

As illustrated in FIG. 1, the employee and the employer are each operable to utilize their respective electronic device to communicate with the employee benefits management system 102. In some embodiments, the employer operates the second electronic device 110 to transmit a request to view benefits that the employee is qualified to receive on or prior to the employee's pay date. As defined herein, a pay date is a designated date or period the employee is scheduled to receive compensation. For example, if the employee's compensation is scheduled to be disbursed at the end of each month, the employer may determine benefits that the employee is qualified to receive prior to the end-of-the-month, and authorize disbursement of one or more of the benefits the employee is qualified to receive (“qualified benefits” or “qualifying benefits”). As defined herein, a benefit is a form of consideration having a monetary value and may be exchanged for goods or services from a third party. Examples of benefits include, but are not limited to one or more forms of cash payments, general purpose reloadable debit cards, gift cards, pre-paid tickets (such as tickets to attend a sporting event, a musical, or other events), coupons, rewards or loyalty points that may be used towards rewards offered by participating vendors, and other types of consideration having a monetary value. Although FIG. 1 illustrates the first electronic device 108 as a smart phone, and the second electronic device 110 as a desktop computer, the first electronic device 108 and the second electronic device 110 may also be a laptop computer, a tablet computer, a smart watch, a PDA, as well as similar electronic devices having hardware, software, and/or firmware that are operable to initiate a request to disburse employee compensation to the employee benefits management system 102. In some embodiments, the second electronic device 110 is also operable to authorize a financial transaction (e.g., via ACH, wire transfer, or another type of currency transfer) to an account of the Company to repay (either partially or in full) an employee compensation payment previously authorized by the benefits management system 102 and paid to the employer.

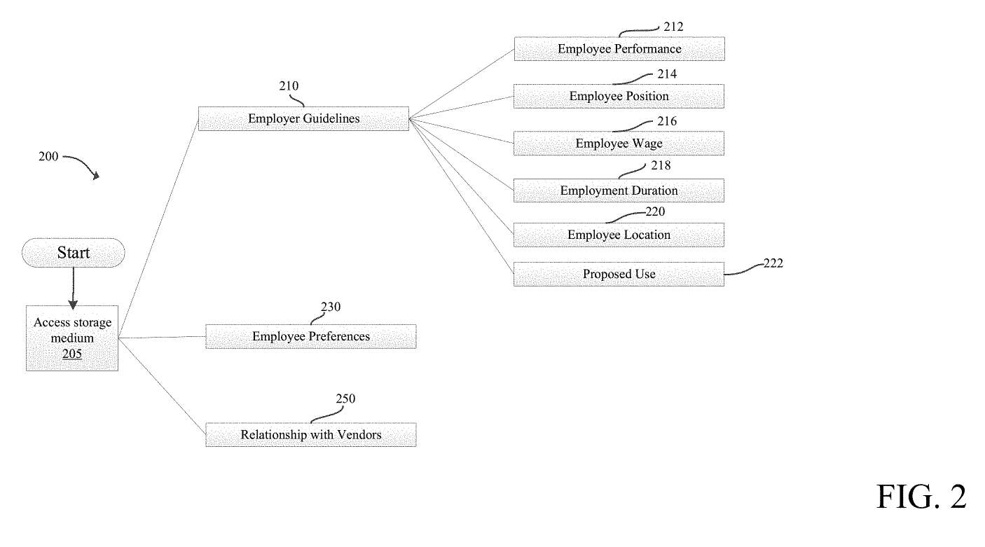

The employee benefits management system 102, upon receipt of such request, performs operations described in the following paragraphs and illustrated in at least FIG. 2 to determine benefits that the employee is qualified to receive. In one of such embodiments, the employee benefits management system 102 is further operable to determine any compulsory contribution to a governmental entity (collectively “taxes”) and any fees paid to the Company (collectively “charge” or “charges”). In further embodiments, the employee benefits management system 102 is operable to receive a request from the employee's electronic device 108 to provide benefits to the employee, and is further operable to perform operations described herein to process the request.

The employee benefits management system 102, upon receipt of a request to provide benefits to the employee, accesses storage medium 104 to obtain business rules for determining qualifying benefits, and to obtain machine-readable instructions, which when executed by a processor of the employee benefits management system 102, cause the processor to perform operations described herein. The storage medium 104 may be formed from data storage components such as, but not limited to, read-only memory (ROM), random access memory (RAM), flash memory, magnetic hard drives, solid state hard drives, CD-ROM drives, DVD drives, floppy disk drives, as well as other types of data storage components and devices. In some embodiments, the storage medium 104 includes multiple data storage devices. In further embodiments, the multiple data storage devices may be physically stored at different locations. In one of such embodiments, the data storage devices are components of a server station, such as a cloud server. In another one of such embodiments, the data storage devices are components of the employee benefits management system 102.

In some embodiments, consumer financing agencies as well as other regulatory agencies have enacted Laws (as defined below) to govern and to restrict third party lending practices to consumers, including, but not limited to requiring credit checks before loans are granted, regulating the amount, or regulating the interest rate, tees, and charges associated with loans to consumers to protect consumers from unscrupulous lending practices. Further, while an employer may loan money to an employee over the employee's accrued wages, such practices would subject the employer to the same or similar Laws (such as consumer finance laws) as non-employers. In one of such embodiments, the present disclose relates to systems and methods to lend to an employer an amount that has been accrued by an employee of the employer to pay for an employee benefit. In such embodiments, the third party lender not only provides the employer with a loan to pay for an employee benefit, but also does not subject the employer to additional Laws that non-employer entities would be subject to if the money is directly received from a non-employer entity. In other embodiments, where consumer finance laws are complied with (such as in a jurisdiction (such as another country) where no such Laws exist), the systems and methods described herein allow employees to draw down some amount more than their accrued wages. For example, the systems and methods described herein would allow the employees to withdraw their wages up to one extra week, until the end of the month, no more than $500 on top of accrued, or based on a quantifiable metric. In each of the foregoing embodiments, the business rules define how to determine qualifying benefits in accordance with the Law. More particularly, the business rules for determining qualifying benefits include a category of business rules that define the employer's guidelines. In some embodiments, the employer's guidelines for determining qualifying benefits include rules that specify the qualifying benefits based on the employee's performance, the employee's position, the employee's current wage, amount earned by the employee during the current pay period, the employee's experience level, the employee's location of residence, the employee's proposed use of the benefit, as well as other factors described herein. For example, the employer's guidelines define that an employee deemed to be an “outstanding employee” qualifies for gift cards from all participating vendors, pre-paid debit cards, tickets to a sporting event, and cash payments, that an employee deemed to be a “good employee” qualifies for gift cards from participating vendors and pre-paid debit cards, and an employee deemed to be an “average employee” only qualifies for gift cards from certain participating vendors. The employer may define other thresholds and ranges of employee performance, and may utilize a variety of grading criterion (including, but not limited to, points, letter grades, as well other types of quantifiable grading criterion) to determine qualifying benefits. In some embodiments, the employer provides the employee with limited options to establish business rules that define the employee's preferences. For example, the employee may designate a preference to receive gift cards from a first vendor, a preference to receive rewards points from a second vendor, and a preference not to receive pre-paid debit cards. In such embodiments, the employee may also designate a disbursement date, a disbursement amount, and a disbursement frequency of the qualifying benefit. For example, if the employee has accrued $10,000, the employee may elect to receive $10,000 on the scheduled pay date or to receive an alternate payday payment on another date. The employee may also elect to receive all (or a portion of) the $10,000 at once, or to receive multiple payments that collectively add up to $10,000. For example, the employee may elect to receive two $5,000 payments made on one week before the pay date and on the pay date, four $2,500 payments, each made one week apart, one payment each day, or a different number of payments specified by the employee to be paid to the employee at different times). In further embodiments, the employee may also specify a preferred method to pay for the qualifying benefit (such as, for example, purchased from the proceeds of a loan from the employer, or from the proceeds of a drawdown of the employee's wage). In some embodiments, the business rules for determining qualifying benefits is also based on the employer's relationship with different vendors. For example, the employer's “excellent relationship” with a first airline vendor qualifies employees of the employer to use reward points from the first airline vendor on airfare without any blackout days, whereas the employer's “fair relationship” with a second airline vendor qualifies employees of the employer to use reward points that may only be used to pay for in-flight meals offered by the second airline vendor. Additional examples of business rules for determining qualifying benefits are provided in the following paragraphs and are illustrated in at least FIG. 2.

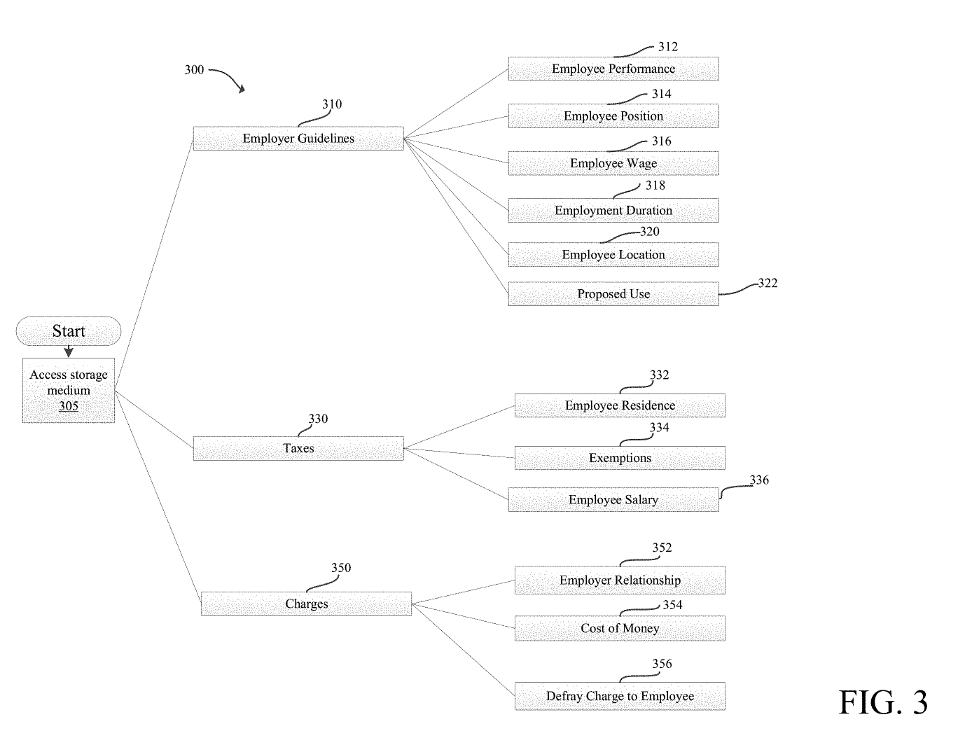

In some embodiments, the storage medium 104 also stores business rules for determining a benefit value of each benefit. As defined herein, a benefit value is a value indicative of the benefit's worth. For example, the value of the benefit may be measured based on a currency or a number of reward points that may be exchanged for goods or services. In such embodiments, the employee benefits management system 102 is operable to obtain the business rules for determining a benefit value of each qualifying benefit. In one of such embodiments, the business rules for determining the benefit value include a category of business rules that define the employer's guidelines for making such determination. In some embodiments, the employer's guidelines for calculating the benefit value is based on the employee's performance, the employee's position, the employee's current wage, amount earned by the employee, the employee's experience level, the employee's location of residence, the employee's proposed use of the benefit, the proposed date of disbursement, as well as other factors described herein. For example, the employer's guidelines define that the benefit value of an alternate pay date payment may be less than or equal to 66% of the employee's current monthly compensation if the employee is deemed to be an “outstanding” employee. As defined herein, an alternate pay date payment occurs when the employee receives a benefit (such as a cash payment, a gift card, or another type of payment described herein) prior to the employee's upcoming pay date. Continuing with the foregoing example, the benefit value of the alternate pay date payment may be less than or equal to 50% of the employee's current monthly compensation if the employee is deemed to be a “good employee,” and the benefit value of the alternate pay date payment may be less than 33% of the employee's current monthly compensation if the employee is deemed to be an “average employee.” Additional examples of business rules that define the employer's guidelines for determining benefit values of qualifying benefits are provided in the following paragraphs and are illustrated in at least FIG. 3.

In further embodiments, the business rules for determining the benefit value of a qualifying benefit also include a second category of business rules for determining taxes levied by the government and for adjusting the benefit value to account for applicable taxes. In one of such embodiments, the employee benefits management system 102 has access to the salary of the employee, exemptions claimed by the employee, residence of the employee, as well as other employee information to determine the amount of taxes to be withheld. The employee benefits management system 102 then applies business rules for determining taxes based on the employee information and determines applicable tax statutes and codes to determine the amount of taxes to be withheld.

In further embodiments, the business rules for determining the benefit value of a qualifying benefit also include a third category of business rules for determining the charge associated with providing the benefit system to the employer. In one of such embodiments, the charge includes the cost of money associated with providing the benefit to the employer, cost associated with maintaining the employee benefits management system 102 (including providing technical support), as well as other expenses described herein. In another one of such embodiments, the charge is determined based on a combination of the cost of money, the Company's relationship with the employer, as well as other factors described herein. In another one of such embodiments, the employer may elect to defray a portion of the charge that is passed along to the employee. In such embodiments, the employee benefits management system 102 is operable to calculate the charge and to adjust the benefit value of the benefit to pay for the charge. For example, if the benefit is an alternate pay date payment, has a value of $1,000, and the charge associated with providing the $1,000 alternate pay date payment is $100, then the $1,000 alternate pay date payment may be reduced by $100 (or a portion of the charge) to pay for the charge. Additional examples of business rules for determining taxes and charges are provided in the following paragraphs and are illustrated in at least FIG. 3.

The employee benefits management system 102, upon determining qualifying benefits, provides the benefits for display on the second electronic device 110. In some embodiments, the employee benefits management system 102 is operable to manage an employer benefits account of the employer and is operable to provide account information of the employer's management account for display on the second electronic device 110. As defined herein, an employer benefits account is any account containing benefits available to the employees, benefit values of benefits provided to the employees, compensations of the employees, taxes to be withheld, charges to be withheld, or other information used by the employee benefits management system 102 to determine the benefit values of benefits provided to different employees, to track previous benefits provided to employees, to make adjustments to different employee compensations, or to make other types of calculations or adjustments. In some embodiments, the employer operates the second electronic device 110 to select one or more benefits to provide to the employee. In some embodiments, the employer selects a date the employee is scheduled to receive the benefit, whether the qualified benefit should be disbursed altogether or split into partial disbursements over a period of time, the structure of the disbursement (such as direct deposit, debit card, check, or other forms of payment), as well as other quantifiable elections on how the disbursement amount should be paid.

In some embodiments, where the qualified benefit is provided in lieu of accrued compensation, the employee benefits management system 102 is operable to determine an adjustment made to the earned but unpaid compensation. For example, if the employee's monthly compensation is $10,000, to be paid at the end of each month, and the qualified benefit is a $5,000 payment, to be paid on the 10^{th} of the month, then the employee benefits management system 102 is operable to determine that the employee's end-of-the-month compensation should be reduced by $5,000 (in additional charges defrayed by the employee). In one of such embodiments, the employee benefits management system 102 is operable to provide a notification to the second electronic device 110 to reduce the end-of-the-month compensation of the employee.

In some embodiments, where the employee benefits management system 102 directly manages the employer's payroll or the employee's compensation, the employee benefits management system 102 is operable to automatically perform the adjustment to the employer's payroll and the employee's compensation based on the disbursement amount and any additional charges. In one of such embodiments, the employee benefits management system 102 is communicatively connected to an employer time & attendance payroll system, tax return system, as well as other systems operable to manage the employer's payroll and tax payments. In another one of such embodiments, the foregoing systems are components of the employee benefits management system 102.

In some embodiments, some of the foregoing elections may be subject to relevant laws. In such embodiments, the employee benefits management system 102 applies statutes, codes, rules, regulations, legislations or other types of requirements enacted by the government (collectively “laws”). In one of such embodiments, a first state government may permit the employee benefits management system 102 to provide the benefit as a loan to the employee if the employee resides in the first state, whereas a second state government may require the employee benefits management system 102 to consider the benefit as a draw of the employee's compensation. In another one of such embodiments, different state governments require different amounts of taxes to be associated with the benefit. In a further one of such embodiments, where different state governments have enacted different laws for determining charges associated with providing the benefit, the employee benefits management system 102 applies the applicable laws to calculate the charges.

In some embodiments, the employee benefits management system 102 is operable to manage an employee benefits account of the employee. As defined herein, an employee benefits account is any account containing records of benefits provided to the employee, the benefit values of such benefits, the employee's compensation (including, but not limited to total compensation and accrued compensation prior to the scheduled pay date), the employee's time and attendance, taxes to be withheld, charges to be withheld, or any other financial data used by the employee benefits management system 102 to determine the benefit value of the benefit, to track previous benefits provided to the employee, to make adjustments to the employee's compensation, or to make other types of calculations or adjustments based on the benefit. In one of such embodiments, the employee benefits management system 102 manages a separate employee benefits account assigned to each employee of the employer. In another one of such embodiments, the employee benefits management system 102 manages a single employer benefits account for the employer, where the employer benefits account includes an aggregate of benefit values of benefits provided to the employees of the employer. In some embodiments, the employee benefits management system 102 is further operable to dynamically or periodically update the employee benefits account and the employer benefits account to account for compensation earned by the employee, benefit(s) made or to be provided to the employee (via the employer), taxes, charges, as well as other adjustments (such as, but not limited to wage garnishments by the employer, a governmental entity, or another third party, alimony to a third party, child support to a dependent, retirement contribution, and charitable donations) to the employee benefits account or the employer benefits account.

In some embodiments, the employee benefits management system 102 transmits data indicative of the employee benefits account to the first and the second electronic devices 108 and 110. In one of such embodiments, the employee benefits management system 102 is operable to receive credentials from the first and the second electronic devices 108 and 110, perform one or more verifications of the received credentials, and transmit data indicative of the employee benefits account to the first and second electronic devices 108 and 110 upon verifying the credentials of the first and the second electronic devices 108 and 110, respectively. In one of such embodiments, an application running on the first electronic device 108 is operable to transmit the request to access the employee benefits amount to the employee benefits management system 102. In another one of such embodiments, the employee benefits management system 102 also provides the second electronic device 110 with access to the employee benefits account. In further embodiments, the employee benefits management system 102 is operable to provide the second electronic device 110 with access to the employer benefits account. In that regard, the employer may monitor the aggregate benefit values of the qualified benefits provided to the employees, specific benefits provided to specific employees, total compensation of the employees, specific employee compensations, adjustments made to specific employee compensations, taxes, aggregate charges over a period of time from benefits provided during the period of time, specific charges made to employee compensations, adjustments made to specific employee compensations, as well as monitor financial data indicative of individual or aggregate employees compensations.

In some embodiments, the employee benefits management system 102 is operated by an employer or is a component of a system operated by or owned by the employer. In such embodiments, the employee benefits management system 102 is operable to directly communicate with electronic devices of employees of the employer to perform operations described herein. In such embodiments, the employee benefits management system 102 is operable to receive a request from an employee's electronic device, such as the first electronic device 108, to provide a benefit to the employee. The employee benefits management system 102 then performs operations described herein to determine which benefits are qualified for the employee and provides a selection of benefits qualified for the employee to the first electronic device 108. The employee selects a benefit via the first electronic 108 and transmits the selected benefit to the employee benefits management system 102 via network 106. The employee benefits management system 102, upon receipt of the benefit selected by the employee, authorizes the selected benefit and updates the employer's payroll account, tax account, time and attendance, access time, as well as other financial accounts of the employer once the selected benefit is disbursed to the employee.

The network 106 can include, for example, any one or more of a cellular network, a satellite network, a personal area network (PAN), a local area network (LAN), a wide area network (WAN), a broadband network (BBN), a RFID network, a Bluetooth network, a device to device network, the Internet, and the like. Further, the network 106 can include, but is not limited to, any one or more of the following network topologies, including a bus network, a star network, a ring network, a mesh network, a star-bus network, tree or hierarchical network, or similar network architecture. The network 106 may be implemented using different protocols of the internet protocol suite such as TCP/IP. The network 106 includes one or more interfaces for data transfer. In some embodiments, the network 106 includes a wired or wireless networking device (not shown) operable to facilitate one or more types of wired and wireless communication between the employee benefits management system 102, the first electronic device 108, the second electronic device 110, as well as other electronic devices (not shown) communicatively connected to the network 106. Examples of the networking device include, but are not limited to, wired and wireless routers, wired and wireless modems, access points, as well as other types of suitable networking devices described herein. Examples of wired and wireless communication include, Ethernet, WiFi, Cellular, LTE, GPS, Bluetooth, RFID, as well as other types of communication modes described herein.

Although FIG. 1 illustrates an electronic device of one employee connected to the employee benefits management system 102 via the network 106, additional electronic devices (not shown) operated by additional employees of the employer may also be communicatively connected to the employee benefits management system 102 via the network 106. In some embodiments, the employee benefits management system 102 is operable to simultaneously perform multiple operations described herein to provide each electronic device with access to an employee benefits account of an employee operating the respective electronic device. Further, although FIG. 1 illustrates the electronic device 110 of one employer, the employee benefits management system 102 may also be communicatively connected to additional electronic devices (not shown) of the employer, or operated by other employers. In one of such embodiments, the employee benefits management system 102 is operable to simultaneously perform the operations described herein to manage employee benefits of multiple employers and to provide each employer with access to an employer benefits account of the employer.

FIG. 2 is a tree diagram illustrating a process to determine which benefits the employee is qualified for in accordance with one embodiment. Although operations in the process 200 are shown in a particular sequence, certain operations may be performed in different sequences or at the same time where feasible. Further, in some embodiments, different combinations of some or all of the steps of the process 200 are performed to obtain the business rules to determine qualifying benefits. Further, although the following paragraphs describe a processor of the employee benefits management system 102 performing various operations, the employee benefits management system 102 may utilize multiple processors (or processor cores) to perform such operations.

As stated herein, the business rules for determining qualifying benefits are stored in the storage medium 104 and include business rules (or categories of business rules) to determine the benefits based on the employer's guidelines, employee's preferences, the employer's relationship with vendors, as well as other quantifiable measurements. At step 205, the processor, upon receiving a request to provide a benefit to the employee, accesses the storage medium 104 to obtain applicable business rules to determine qualifying benefits. At step 210, the processor obtains a first category of the business rules that define the employer's guidelines for determining the benefits. This category is further divided into sub-categories to provide more granular categorizations of business rules that should be applied to determine the benefits.

At step 212, the processor accesses the employee performance sub-category to determine applicable business rules that define determining qualifying benefits based on the employee's performance. As described herein, the business rules that define determining qualifying benefits based on the employee's performance include a variety of employer-customizable business rules that define which benefits the employee qualifies for based on the employee's performance. In some embodiments, where the employer provides a value indicative of the employee's performance (“performance value”), the processor applies the business rules that define determining qualifying benefits based on the employee's performance to determine the qualifying benefits based on the employee performance value provided by the employer. In one of such embodiments, the business rules that define determining qualifying benefits based on the employee's performance also include employer-customizable business rules that define how to calculate the payment date and the ratio based on the employee's performance value. For example, if the employer assigns the employee performance value between 90-100, then the employee would be eligible to receive gift cards, alternate pay date payments, or reward points. However, if the employer assigns the employee a performance value lower than 50, then the employee would not be eligible to receive any benefit.

In some embodiments, the processor is also operable to utilize the business rules that define determining qualifying benefits based on the employee's performance rules to determine the employee's performance value. In one of such embodiments, the processor is operable to utilize these business rules to determine the employee's performance value based on the employee's current performance or performance over a period of time (such as the last week, the last month, the last year, or another quantifiable period of time) to determine the employee's performance value. For example, if the employee has received an excellent review from his supervisor, then the employee's performance value is boosted by ten points, if the employee is named an inventor of a patent application, then the employee's performance value is boosted by twenty points, but if the employee has been tardy for more than three times over the last year, then one point is deducted from the employee's performance value for each tardy over three. In such embodiments, the processor is further operable to determine the qualifying benefits based on the calculated performance value of the employee.

In some embodiments, the business rules that define determining qualifying benefits based on the employee's performance include a business rule that limits the disbursement date based on the performance value of the employee. For example, the foregoing business rule limits the disbursement date of qualifying benefits to be no earlier than three weeks, two weeks, or one week prior to a scheduled respective pay dates for an excellent employee, a good employee, and an average employee.

At steps 214, 216, and 218, the processor accesses the employee position sub-category, the employee wage category, and the employment duration sub-category, respectively, to determine applicable business rules that define determining which benefit the employee qualifies for based on the employee's position, the employee's wage, and the employee's employment duration, respectively. These business rules, similar to the business rules that define determining qualifying benefits based on the employee's performance, also include a variety of employer-customizable business rules that define which benefits the employee qualifies for based on the employee's position, wage, or employment duration. Although steps 210, 212, 214, 216, 218, 220, and 222 describe obtaining various business rules that define the employer's guidelines for determining the benefits in some embodiments, some of all of the business rules that define such guidelines are set aside (at the Company's discretion or at the discretion of the employee benefits management system 102). In other embodiments, the Company may designate some or all of the business rules to apply to every employee of the employer.

At step 220, the processor accesses the employee location sub-category to determine applicable business rules that define determining which benefit the employee qualifies for based on the location of the employee. In some embodiments, these business rules specify laws that regulate which qualifying benefit may be provided to the employee, the structure of the benefit, taxes to be collected, whether a charge may be assessed to the benefit, as well as other applicable laws based on the location of the employee. In one of such embodiments, the business rules for calculating taxes based on the employee's residence include a business rule that specifies how to structure the benefit (in the form of a loan, a direct draw, or another payment structure) to comply with the laws. For example, the processor is operable to apply the laws of a first jurisdiction to structure the qualifying benefit as a loan if the employee is a resident of the first jurisdiction, and is operable to apply the laws of a second jurisdiction to structure the qualifying benefit as a direct draw if the employee is a resident of the second jurisdiction.

In some embodiments, the employee benefits management system 102 receives a proposed use of the disbursement amount. In such embodiments, the business rules that define the employer's guidelines for determining qualifying benefits includes a proposed use sub-category that includes employer-customizable business rules that define which benefits the employee qualifies for based on the employee's proposed use. At step 222, the processor accesses the proposed use sub-category to determine business rules that define which benefits the employee qualifies for based on the employee's proposed use. For example, if the proposed use is for Thanksgiving shopping, then the qualifying benefits include gift cards to grocery stores, and pre-paid debit cards.

At step 230, the processor obtains a second category of the business rules that define the employee's preferences (“employee preferences category”). The employee preferences category includes employer approved business rules that define the employee's preferences on the qualifying benefits. Examples of employee preferences include, preferred vendors, preferred date to receive the benefit, preferred benefit structure, as well as other employee preferences that have been pre-approved by the employer. At step 250, the processor obtains a third category of business rules that define the employer's relationship or the Company's relationship with vendors (“relationship with vendors category”). The relationship with vendors category includes business rules that define available benefits based on the employer's or the Company's relationship with the vendor. For example, a 15% discount coupon on new automobiles manufactured by an automobile vendor is available to qualifying employees due to the Company's relationship with the automobile vendor. Although the foregoing paragraphs describe performing the process 200 to determine qualifying benefits of one employee, the process 200 may be repeated to simultaneously determining qualifying benefits of multiple employees of the employer or multiple employers.

FIG. 3 is a tree diagram illustrating a process 300 to determine a benefit value of a benefit in accordance in accordance with one embodiment. Although operations in the process 300 are shown in a particular sequence, certain operations may be performed in different sequences or at the same time where feasible. Further, in some embodiments, different combinations of some or all of the steps of the process 300 are performed to obtain the business rules to determine the benefit value. Further, although the following paragraphs describe a processor of the employee benefits management system 102 performing various operations, the employee benefits management system 102 may utilize multiple processors (or processor cores) to perform such operations.

As stated herein, the business rules for determining a benefit value associated with a benefit are stored in the storage medium 104 and include business rules (or categories of business rules) to determine the disbursement amount based on employer's guidelines, applicable taxes, charges, as well as other quantifiable measurements. At step 305, the processor, upon receiving a request to provide a benefit to the employee, accesses the storage medium 104 to obtain applicable business rules to determine the benefit value. At step 310, the processor obtains a first category of the business rules that define the employer's guidelines (“employer guidelines category”) for determining the benefit value. The employer guidelines category is further divided into sub-categories to provide more granular categorizations of business rules that should be applied to determine the benefit value.

At step 312, the processor accesses the employee performance sub-category to determine applicable business rules that define calculating the benefit value based on the employee's performance (“employee performance business rules”). In some embodiments, the employee performance business rules also include employer-customizable business rules that define how to calculate the ratio of the benefit value relative to the employee's compensation (“disbursement ratio”) based on the employee's performance value.

At step 314, the processor accesses the employee position sub-category to determine applicable business rules that define calculating the benefit value based on the employee's position (“employee position business rules”). The employee position business rules include a variety of employer-customizable business rules that define how to calculate the benefit value based on the employee's position. In some embodiments, the employee position business rules include employer-customizable business rules for determining the disbursement ratio and the disbursement date based on the employee's position with the employer. For example, the employee position business rules include a business rule that limits the disbursement ratio of all entry-level employees to be less than or equal to 35%, all management-level employees to he less than or equal to 50%, and all executive-level employees to be less than or equal to 75%. Moreover, the employee position business rules include another business rule that limits the disbursement date to be no earlier than three weeks, two weeks, or one week prior to an executive-level employee, a management-level employee, or an entry-level employee's respective pay date.

At step 316, the processor accesses the employee wage sub-category to determine applicable business rules that define calculating the benefit value based on the employee's wage (“employee wage business rules”). The employee wage business rules include a variety of employer-customizable business rules that define how to calculate the benefit value based on the employee's wage. For example, the employee wage business rules include a business rule that limits the disbursement ratio to be less than or equal to 90% if the employee's wage is less than $50,000 and limits the disbursement ratio to be less than or equal to 50% if the employee's wage is greater than $100,000. In some embodiments, where an alternate pay day payment is made to the employee (or to the employee through the employer), the employee wage business rules include a business rule that determines the benefit value based on a ratio of the disbursement amount to the amount of compensation earned by the employee. For example, if the employee is an hourly employee paid at $10 per hour, the employee would earn $80 after working for eight hours. In that regard, if the employee is paid every Friday, but seeks an alternate pay date payment on Tuesday after working eight hours on Monday, the processor is operable to apply the business rules, and authorize disbursement of all of the earned amount ($80), or authorize disbursement of a portion of the earned amount based on the ratio of the benefit value to the earned amount. In some embodiments, the employee wage business rules include a variety of other employer-customizable business rules that define calculating the benefit value, the disbursement ratio, the ratio of the benefit value to the amount of compensation earned by the employee, and the disbursement date based on other quantifiable factors related to the employee's wage.

At step 318, the processor accesses the employment duration sub-category to determine applicable business rules that define calculating the benefit value based on the amount of time the employee has been employed with the employer (“employment duration business rules”). The employment duration business rules include a variety of employer-customizable business rules that define how to calculate the benefit value based on the amount of time the employee has been employed with the employer. At step 320, the processor accesses the employee location sub-category to determine applicable business rules that define calculating the benefit value based on the location of the employee (“employee location business rules”). The employee location business rules include a variety of employer-customizable business rules that define how to calculate the benefit value based on the location of the employee. In one of such embodiments, the employee location business rules include a business rule that limits the disbursement ratio to be less than or equal to 75% if the employee resides within a geographic range of a metropolitan area where the cost of living is greater than a first threshold value. In another one of such embodiments, the employee location business rules also include a business rule that limits the disbursement ratio to be less than or equal to 50% if the employee resides in a state (or country) where the cost of living is less than a second threshold value.

In some embodiments, the employee benefits management system 102 receives a proposed use of a benefit. In such embodiments, the employer guidelines category includes a proposed use sub-category that includes employer-customizable business rules that define how to calculate the benefit value based on the employee's proposed use (“proposed use business rules”). At step 322, the processor accesses the proposed use sub-category to determine applicable proposed use business rules. In one of such embodiments, the proposed use business rules include a business rule that permits the disbursement ratio to be 100% if the proposed use is to pay for higher tuition, includes another business rule that limits the disbursement ratio to be 75% if the proposed use is a donation to a charity, and includes another business rule that limits the disbursement ratio to be 50% if the proposed use is for vacationing. In another one of such embodiments, where the Company has defined multiple categories of proposed use (such as for tuition, charity, vacationing, holiday expenses, as well as other types of quantifiable categories), the processor is operable to assign the proposed use to a category of proposed use and to determine the benefit value based on the assigned proposed use category. For example, if the processor determines that the proposed use is for Black Friday shopping, then the processor is operable to assign the proposed used to the holiday expenses category and to obtain a proposed use business rule that defines the benefit value for holiday expenses.

At step 330, the processor obtains a second category of the business rules that define guidelines for calculating taxes (“taxes category”) to be paid to the government. The taxes category is further divided into sub-categories to provide more granular categorizations of business rules that should be applied to determine applicable taxes, such as federal taxes, state taxes, income taxes, social security, Medicare, as well as other applicable payments levied by a governmental entity. At steps 332, the processor accesses an employee residence sub-category to determine business rules for calculating taxes based on the employee's residence. At steps 334 and 336, respectively, the processor accesses an exemptions sub-category and an employee salary sub-category, respectively, to determine business rules for adjusting the benefit value based on available exemptions and to determine business rules for calculating the taxes based on the employee's salary, respectively. In some embodiments, tax-related information is stored on the storage medium 104 and may be readily accessible by the employer via the first electronic device 108. In such embodiments, the processor is further operable to prepare, file, and manage tax payments on behalf of the employer and to periodically provide the employer with data indicative of tax forms prepared on behalf of the employer, tax payments made on behalf of the employer, as well as data indicative of tax-related operations performed by the employee benefits management system 102 on behalf of the employer. In one of such embodiments, the employee benefits management system 102 is further operable to prepare and send tax payments on behalf of the employer.

At step 350, the processor obtains a third category of the business rules that define guidelines for calculating applicable charges (“charges category”). The charges category is further divided into sub-categories to provide more granular categorizations of business rules that should be applied to determine the applicable charges. At step 352, the processor accesses the employer relationship sub-category to determine applicable business rules that define calculating the charges based on existing relationship with the employer (“employer relationship business rules”). The employer relationship business rules include a variety of business rules that define how to calculate the charge based on the Company's existing relationship with the employer. For example, the employer relationship rules include a business rule that limits the charge to be less than 5% of the benefit value if the Company manages more than 100 employee accounts of the employer, and limits the charge to be less than 10% of the benefit value if the Company manages less than 10 employee accounts of the employer.

In some embodiments, the employer relationship rules include another business rule that determines the charge based on the amount of business generated from employer. For example, if the employer pays the Company more than a first threshold payment per year, then the charge would be less than a second threshold percentage of the benefit value, whereas if the employer pays the Company less than the first threshold payment per year, then the charge would be between the second threshold percentage of the benefit value and a third threshold percentage of the benefit value, where the third threshold percentage of the benefit value is greater than the second threshold percentage of the benefit value. In some embodiments, the charge is a flat fee, determined based on the Company's relationship with the employer. In other embodiments, the charge is a variable amount (such as based on the amount of the disbursement amount, time until the financing terms and period of the disbursement amount, cost of money, cost of the employee benefits management system 102, operational expenses related to running and maintaining the employee benefits management system 102, cost associated with technical support offered by the operators of the employee benefits management system 102 to the employer, or another quantifiable variable), determined based on the Company's relationship with the employer. In further embodiments, the charge may be any other quantifiable amount based on the Company's relationship with the employer.

As stated herein, in some embodiments, the Company incurs expenses from performing tasks described herein. At step 354, the processor accesses expenses sub-category to determine applicable business rules that define calculating the charges based on the cost of money incurred by the Company, charges based on the initial cost of the employee benefits management system 102, cost associated with running (including offering technical support) and maintaining the employee benefits management system 102, as well as other expenses incurred by the Company (collectively “expenses business rules”). The expenses rules include a variety of business rules that define how to calculate the charge based on the cost of money incurred by the Company. In one of such embodiments, the expenses business rules include a business rule that defines the cost of money based on a current interest rate (such as the ICE LIBOR rate, the United States Prime Rate, or the interest rate of another financial or governmental institution).

In another one of such embodiments, the expenses business rules include a business rule that defines the cost of money based on the amount of available funds readily available to the Company to disburse to the employer. In a further one of such embodiments, the expenses business rules include a business rule that defines the cost of money based on the amount of time between the date disbursement amount is paid to the employer and the date the disbursement amount is paid back to the Company. For example, the expenses business rules include a business rule that sets the charge to be 10% of the value of the benefit if the employer has one year to pay back funds obtained from the Company to offer the benefit, and include another business rule that sets the charge to be 5% of the value of the benefit (such as, for example the total value of the benefit before taxes and charges are calculated or the value of the benefit paid to the employee) if the employer has one month to pay back the funds obtained from the Company to offer the benefit. In further embodiments, the expenses business rules include a business rules that defines the cost associated with running the employee benefits management system 102 and providing the employer with technical support.

As stated herein, in some embodiments, the employer may elect to pass its expense for offering the benefit to the employee to the employee or it may defray a portion or all of the charge. At step 356, the processor accesses the defray charge to employee sub-category to determine applicable business rules that define calculating the amount of charges to be defrayed to the employee (“defray charges business rules”). In one of such embodiments, the defray charges business rules include a business rule that requires all of the charges to be defrayed by the employer. In further embodiments, the defray charges business rules include a business rule that requires a fixed amount of the charges to be defrayed by the employer. In another one of such embodiments, the defray charges business rules include a business rule that sets a variable defrayment plan based on one or more employer-customizable factors, such as the employee's performance, the employee's position, the employee's wage, the employment duration of the employee, the employee's location, the proposed use, as well as other quantifiable factors. For example, if the employer has selected the employee's performance to be one of the factors for determining variable defrayment of the charge, the processor is operable to perform operations described in step 312 to determine the employee's performance value, and to determine the variable defrayment of the charge based on the employee's determined performance value. In each of the foregoing embodiments, the processor adjusts the benefit value to account for all of the defrayed charges.

In some embodiments, the employee benefits management system 102 is further operable to update a balance of the employer benefits account of the employer based on the benefit value and the charge. In one of such embodiments, where the charge is a variable charge (such as a compounding interest), the employee benefits management system 102 is further operable to calculate the up-to-date balance of the employer benefits account. In such embodiments, the employee benefits management system 102 is further operable to periodically provide the employer with access to the balance of the employer benefits account.

At step 370, the processor obtains a fourth category of the business rules that define guidelines for calculating applicable deductions (“deductions category”). The deductions category is further divided into sub-categories to provide more granular categorizations of business rules that should be applied to determine the applicable deductions. At step 372, the processor accesses the retirement plan sub-category to determine applicable business rules that define calculating the charges based on one or more retirement plans of the employee (“retirement plans business rules”). The retirement plans business rules include a variety of business rules that define various retirement plans (such as 401K, Roth IRA, 403b, as well as other qualifying retirement plans) the employee has established as well as business rules that define how to calculate the employee's contribution to such retirement plans. At step 374, the processor accesses the family plans sub-category to determine applicable business rules that define calculating the charges based on one or more family plans of the employee. In some embodiments, the family plans business rules include a variety of business rules that define various health plans the employee has established for members of the employee's family (including the employee) as well as business rules that define how to calculate the employee's contribution to such health plans. In other embodiments, the family plans business rules include a variety of business rules that define various educational plans (such as 529 plans, college savings plans, k-12 savings plans, as well as other types of educational plans) the employee has established for members of the employee's family (including the employee) as well as business rules that define how to calculate the employee's contribution to such educational plans. In some embodiments, the family plans business rules include a variety of business rules that define plans associated with spousal support and child support as well as business rules that define how to calculate the employee's contribution to provide spousal and child support. Although the foregoing paragraphs describe performing the process 300 to manage the employee compensation of one employee, the process 300 may be repeated to simultaneously manage the employee compensation of multiple employees of an employer or multiple employers.

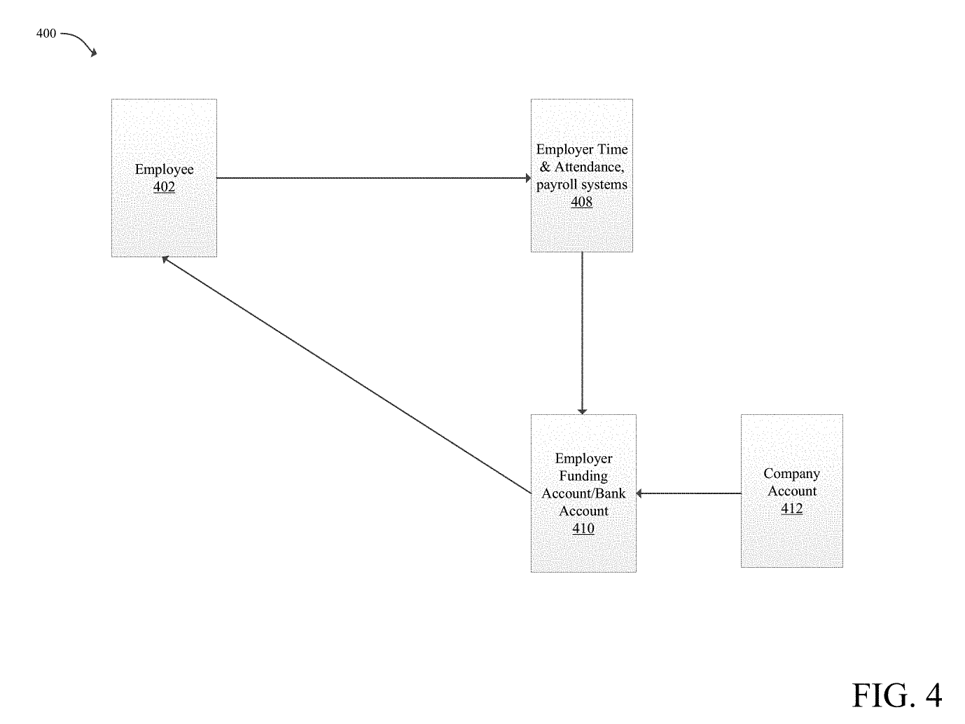

FIG. 4 is a block diagram 400 illustrating interactions between the employee, the employer, and the Company in accordance to one embodiment. The employee 402 submits a request to receive a benefit. In some embodiments, the request is sent directly via an electronic device of the employee 402, such as the first electronic device 108, to the employee benefits management system 102. In other embodiments, the request is sent to an electronic device of the employer, such as the second electronic device 110, and forwarded by the second electronic device 110 to the employee benefits management system 102. The employee benefits management system 102 accesses the employer's time attendance and payroll systems 408 to obtain the employee's time and attendance since the employee's last payday and the employee's current compensation. In some embodiments, the time attendance and payroll systems 408 are components of the employee benefits management system 102. In other embodiments, the time attendance and payroll systems 408 are components of a system operated by the employer. In some embodiments, the employee benefits management system 102 also accesses additional employee information such as the employee's performance rating, the employee's position, the employee's experience level, the employee's location of residence, the employee's proposed use of the benefit, as well as other information described herein to determine benefits available to the employee. Detailed examples of processes performed by the employee benefits management system 102 to determine qualifying benefits are described in the paragraphs above and are illustrated in at least FIG. 2.

The employee benefits management system 102 also determines a benefits value associated with each qualifying benefit. Detailed examples of processes performed by the employee benefits management system 102 to determine benefits values are described in the paragraphs above and are illustrated in at least FIG. 3. The employee benefits management system 102 then transfers the determined benefit value associated with the qualifying benefit from company account 412 to the employer funding account 410. Although the block diagram 400 illustrates the benefit being transferred from the company account 412 to the employer funding account 410, the operations described herein are not limited to bank transactions. For example, in some embodiments, where the benefit is a voucher worth $100, the Company may purchase the voucher for $100 from a vendor, provide the employer with a code used to redeem the voucher, and update the employer's benefits account to reflect $100 plus any applicable charge is owed to the Company.

The employer funding account 410 then transfers the determined employee benefits value to the employee 402. In some embodiments, where a charge (such as a cost of money for advancing the benefit to the employer, expenses associated with maintaining the employee benefits management system 102, as well as other applicable expenses) is assessed to the employer, the employer may elect to pass along all or a portion of the charge to the employee or the employer may elect to defray some or all of the charge. In such embodiments, the employee benefits management system 102 reduces the benefits value by the amount passed along to the employee and provides the difference to the employer funding account 410. The employer then authorizes the employer funding account 410 to transfer the benefit to the employee 402. In some embodiments, where the benefit is a cash payment, the employer may provide the benefit via an ACH transfer, wire transfer, transfer to a general purpose reloadable debit card, or another form of authorized transfer to an account of the employee 402. In other embodiments, where the benefit is a gift card, the employer may purchase the gift card with funds received from the company account 412 and provide the gift card to the employee. In one of such embodiments, the employer repays the Company an amount equivalent to the value of the gift card plus any applicable charges at close of a payroll cycle.

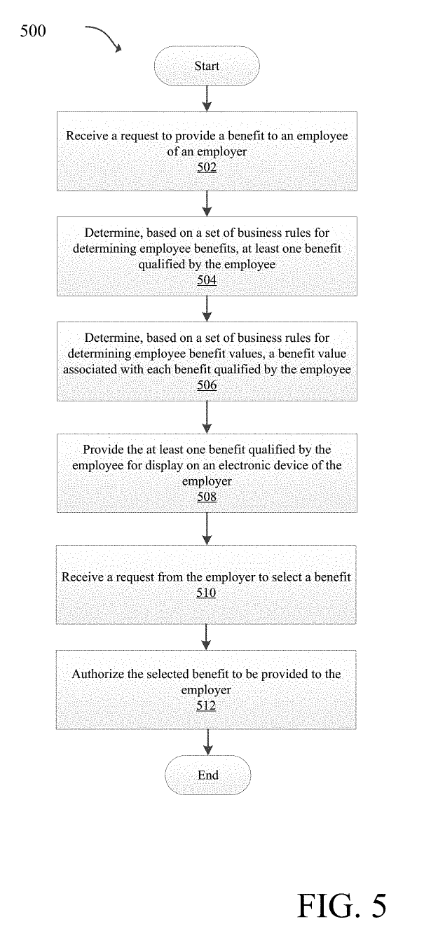

FIG. 5 is a flowchart illustrating a process to manage employee benefits in accordance with one embodiment. Although operations in the process 500 are shown in a particular sequence, certain operations may be performed in different sequences or at the same time where feasible. At step 502, the processor of the employee benefits management system 102 receives a request to provide a benefit to an employee of an employer. In the embodiment of FIG. 1, the request is transmitted by the second electronic device 110. In other embodiments, the request is transmitted by an electronic device of the employee. At step 504, the processor determines, based on a set of business rules for determining employee benefits, at least one benefit qualified for the employee. In some embodiments, the processor performs the operations illustrated in FIG. 2 to determine which benefits the employee is eligible to receive. In one of such embodiments, the processor performs operations described in step 212 to determine the benefits based on the employee's performance. In another one of such embodiments, the processor performs operations described in step 214 to determine the benefits based on the employee's position with the employer. In a further one of such embodiments, the processor performs operations described in step 220 to determine the benefits based on the employee's residence. The processor is operable to perform any combination of operations described in the process 200 to determine which benefits the employee is eligible to receive.

At step 506, the processor determines, based on a set of business rules for determining employee benefit values, a benefit value associated with each benefit the employee is eligible to receive. In some embodiments, the processor performs the operations described in the process 300 to determine the benefit value of each benefit the employee is eligible to receive. In some embodiments, where the benefit is taxable, a portion of the benefit value adjusted by the value of the eligible tax. In one of such embodiments, the processor performs operations described in step 330 to determine the eligible tax. In further embodiments, where the employer has elected to defray a portion of the charge associated with the Company providing the benefit to the employer (to provide to the employee), the benefit value is also adjusted by the value of the charge defrayed to the employee. In one of such embodiments, the processor performs operations described in step 350 to determine the value of the charge defrayed to the employee.

At step 508, the processor provides each benefit the employee is eligible to receive for display on the electronic device of the employer, such as the second electronic device 110. In some embodiments, the processor is operable to provide data indicative of the employer benefits account for display on the second electronic device 110, where the second electronic device 110 is operable to run an application to provide the received data indicative of the employer benefits account for display on the second electronic device 110. In one of such embodiments, the processor is operable to display a listing of all of the benefits determined in step 506 as well as a benefit value (determined in step 508) associated with each benefit for display on the second electronic device 110. At step 510, the employer operates the second electronic device 110 to select a benefit. The second electronic device 110 then transmits data indicative of the selected benefit to the employee benefits management system 102. At step 512, the processor, upon receipt of the selected benefit, authorizes the selected benefit to be provided to the employer. In some embodiments, where the selected benefit is a cash-type benefit, the processor is operable to authorize a financial transaction (e.g., via ACH, wire transfer, or another type of currency transfer) to an account of the employer. In other embodiments, where the selected benefit is a non-cash type benefit, such as a gift card, the processor is operable to obtain the non-cash type benefit, and provide the non-cash type benefit to the employer. In further embodiments, the processor is operable to authorize a variety of operations described herein to obtain the benefit and provide the benefit to the employer for subsequent disbursement to the employee. In some embodiments, the processor is further operable to access payroll account, tax account, time and attendance, access time, as well as other financial accounts of the employer and to update these accounts once the selected benefit has been disbursed to the employee. In one of such embodiments, the processor is further operable to periodically update the foregoing accounts and to provide up-to-date information indicative of the values of these accounts to the second electronic device 110.

As used in this specification and any claims of this application, the terms “computer”, “server”, “processor”, and “memory” all refer to electronic or other technological devices. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification.

The above-disclosed embodiments have been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/blocks may be performed in parallel or out of sequence, or combined into a single step/block. The scope of the claims is intended to broadly cover the disclosed embodiments and any such modification.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A computer-implemented method to manage employee payroll, comprising:
receiving a request from an employer to provide a benefit to an employee of the employer;
determining, based on a set of business rules for determining employee benefits, at least one benefit qualified for the employee;
providing the at least one benefit qualified for the employee for display on an electronic device of the employer;
receiving a request from the employer to select a benefit of the at least one benefit;
authorizing the benefit selected by the employer to be disbursed to the employer; and
updating a payroll account of the employer based on a benefit value of the benefit selected by the employer.

2. The computer-implemented method of claim 1, further comprising determining a performance level of the employee, wherein the business rules for determining employee benefits comprises a business rule for determining the at least one benefit qualified for the employee based on the performance level of the employee.

3. The computer-implemented method of claim 1, further comprising determining a position of the employee, wherein the business rules for determining employee benefits comprises a business rule for determining the at least one benefit qualified for the employee based on the position of the employee.

4. The computer-implemented method of claim 1, further comprising determining a geographical location of the employee, wherein the business rules for determining employee benefits comprises a business rule for determining the at least one benefit qualified for the employee based on the geographical location of the employee.

5. The computer-implemented method of claim 1, further comprising determining compensation of the employee, wherein the business rules for determining employee benefits comprises a business rule for determining the at least one benefit qualified for the employee based on a ratio of the compensation of the employee.

6. The computer-implemented method of claim 1, further comprising determining a proposed use of the disbursement amount, wherein the business rules for determining employee benefits comprises a business rule for determining the at least one benefit qualified for the employee based on based on the proposed use.

7. The computer-implemented method of claim 1, further comprising:
accessing a payroll account of the employer;
updating the payroll account of the employer to reflect the benefit selected by the employer; and
providing the electronic device of the employer with access to the payroll account of the employer.

8. The computer-implemented method of claim 7, further comprising:
determining taxes associated with the benefit selected by the employer; and
updating the payroll account of the employer to account for the taxes associated with the benefit selected by the employer.

9. The computer-implemented method of claim 8, further comprising:
calculating, based on a set of business rules for determining an employee benefit value, a value associated with the benefit selected by the employer; and
adjusting the employee benefit value based on the taxes.

10. The computer-implemented method of claim 1, further comprising:
determining a charge associated with providing the benefit selected by the employer; and
updating a balance of an employer charge account based on the charge, wherein the balance of the employer charge account is indicative of an amount owed by the employer.

11. The computer-implemented method of claim 10, further comprising:
defraying a portion of the charge to the employee; and
reducing the benefit selected by the employer to cover the portion of the charge defrayed to the employee.

12. The computer-implemented method of claim 1, further comprising:
updating an employee benefits account of the employee to include the benefit selected by the employer; and
providing the employee benefits account for display on an electronic device of the employee.

13. The method of claim 1, further comprising:
determining a value of a wage accrued by the employee;
determining if a value of the benefit selected by the employer is greater than the value of the wage accrued by the employee, and
in response to a determination that the value of the benefit selected by the employer is greater than the value of the wage accrued by the employee, limiting the value of the benefit selected by the employer to the value of the wage accrued by the employee.

14. An employee benefits management system comprising:
a processor operable to:
receive a request from an employee to provide a benefit to an employee of the employer;
determine, based on a set of business rules for determining employee benefits, at least one benefit qualified for the employee;
provide the at least one benefit qualified for the employee for display on an electronic device of the employee;
receive a request from the employee to select a benefit of the at least one benefit;
authorize the benefit selected by the employee to be provided to the employee; and
update a payroll account after the benefit selected by the employee is dispersed to the employee.

15. A non-transitory machine-readable medium comprising instructions stored therein, which when executed by one or more processors, cause the one or more processors to perform operations comprising:
receiving a request from an employer to provide a benefit to an employee of the employer;
determining, based on a set of business rules for determining employee benefits, at least one benefit the employee has accrued;
providing the at least one benefit the employee has accrued for display on an electronic device of the employer;
receiving a request from the employer to select a benefit of the at least one benefit the employee has accrued;
authorizing the benefit selected by the employer to be provided to the employer;
determining a charge associated with providing the benefit selected by the employer; and
updating a balance of an employer charge account based on the charge, wherein the balance of the employer charge account is indicative of an amount owed by the employer;
updating a payroll account of the employer to reflect the benefit selected by the employer; and
providing the electronic device of the employer with access to the employer charge account and the payroll account of the employer.
